(19) United States
(12) Patent Application Publication
(10) Pub. No.: US 2026/0277481 A1
(43) Pub. Date: Sep. 17, 2026

(54) STORAGE DEVICE AND DATA MANAGEMENT METHOD THEREOF

(71) Applicant: Hosin Global Electronics Co., LTD, Shenzhen (CN)

(72) Inventors: Weiqin ZHAN, Shenzhen (CN); Yaokai SANG, Shenzhen (CN); Haili LIN, Shenzhen (CN); Zhenyu LIN, Shenzhen (CN)

(73) Assignee: Hosin Global Electronics Co., LTD, Shenzhen (CN)

(21) Appl. No.: 19/417,362

(22) Filed: Dec. 12, 2025

(30) Foreign Application Priority Data
Jan. 10, 2025 (CN) 2025100406193

(51) Int. Cl. G06F 3/06

(52) U.S. Cl. CPC G06F 3/0659; G06F 3/0604

(57) ABSTRACT

The disclosure provides a storage device and a data management method therefor. The storage device includes a storage chip, a control chip, and a security chip coupled to the control chip. The method includes the steps of: in response to a query command, obtaining tag information of the security chip and the storage chip; determining whether the tag information of the security chip matches that of the storage chip; when they do not match, inhibiting the storage device from performing mode switching; when they match, in response to a switching command, controlling the storage device to switch between/among the plurality of modes; and in response to an access command, accessing the storage chip based on the mode was just switched to. Based on this, the disclosure can balance both the security and convenience of storage devices such as solid-state drives during the data reading and writing operations.

This non-provisional patent application claims priority under 35 U.S. C. §119 from Chinese Patent Application No. 2025100406193 filed on Jan. 10, 2025, the entire content of which is incorporated herein by reference.

### TECHNICAL FIELD

The disclosure relates to the field of storage technology, specifically to a storage device and a data management method therefor.

### BACKGROUND

In today's digital world, data security has become the primary concern of individual users as well as enterprise organizations. During the read/write operations of storage devices, sensitive data may face risks of theft, leakage, or tampering. Storage devices represented by solid-state drives (SSDs) generally encrypt read/write data through built-in encryption algorithms. However, the encryption algorithms are confronted with issues such as key management and encryption algorithm vulnerabilities, which may lead to data breaches during storage or transmission. To address this, the industry has provided a storage device integrated with a security chip. As a hardware security module, the security chip is configured to provide secure key storage and encryption operations. Its core advantage lies in hardware-level security, which can physically isolate the keys used for storing data, thereby preventing malicious attackers from cracking encrypted data through software means. However, during data read/write operations, the communication method with the security chip remains the same for each encryption or decryption process, requiring key acquisition from the security chip and identity authentication each time. For certain read/write demands with lower security requirements, this affects the data read/write speed and is not convenient enough.

It is evident that how to ensure storage devices balance both security and convenience during read/write operations is an urgent issue to be resolved at present.

### SUMMARY

In view of this, the disclosure provides a storage device and a data management method therefor, which can improve the problem that storage devices have difficulty balancing security and convenience during read/write operations.

The disclosure provides a data management method for a storage device. The storage device includes a storage chip, a control chip, and a security chip coupled to the control chip. The method includes steps of: in response to a query command, obtaining tag information of the security chip and the storage chip; determining whether the tag information of the security chip matches that of the storage chip; when the tag information of the security chip does not match that of the storage chip, inhibiting the storage device from performing mode switching; when the tag information of the security chip matches that of the storage chip, in response to a switching command, controlling the storage device to switch between/among a plurality of modes; and in response to an access command, accessing the storage chip based on the mode that was just switched to.

The disclosure further provides a storage device, including a storage chip, a control chip, and a security chip coupled to the control chip. Wherein, the control chip is configured to obtain tag information of the security chip and tag information of the storage chip in response to a query command; and to determine whether the tag information of the security chip matches that of the storage chip; when the tag information of the security chip does not match that of the storage chip, the control chip is further configured to inhibit mode switching; when the tag information of the security chip matches that of the storage chip, in response to a switching command, the control chip is further configured to control the storage device to switch between/among the plurality of modes; and in response to an access command, access the storage chip based on the mode was just switched to.

As described above, when the tag information of the security chip and the storage chip match, the storage device may be controlled to switch between a plurality modes (i.e., a first mode and a second mode) and access the storage chip based on the mode was just switched to. The communication methods between the storage chip and the security chip are different under the plurality modes. In this regard, during the data read/write operations, the storage device does not always obtain keys from the security chip and perform identity authentication according to the same mode, which is conducive to achieving a balance between security and convenience.

### BRIEF DESCRIPTION OF THE DRAWINGS

FIG. 1 is a schematic flowchart of a data management method in accordance with an embodiment of the disclosure;

FIG. 2 is a schematic structural diagram of a storage device in accordance with an embodiment of the disclosure;

FIG. 3 is a schematic structural diagram of a security chip shown in FIG. 2 in accordance with an embodiment;

FIG. 4 is a schematic structural diagram of a storage chip shown in FIG. 2 in accordance with an embodiment;

FIG. 5 is a schematic flowchart diagram of performing mode switching in accordance with an embodiment of the disclosure;

FIG. 6 is another schematic flowchart of performing mode switching in accordance with an embodiment of the disclosure;

FIG. 7 is a schematic flowchart of performing data backup in accordance with an embodiment of the disclosure;

FIG. 8 is another flowchart schematic diagram of performing data backup process in accordance with an embodiment of the disclosure.

### DETAILED DESCRIPTION OF THE EMBODIMENTS

To address the above disadvantage in the existing technology, the disclosure provides a storage device and a data management method therefor. These protected subjects are based on the same concept, with basically the same or similar principles for solving problems. The implementation methods of each protected subject may be cross-referenced, and redundant descriptions will not be repeated.

To make the objectives, technical solutions, and advantages of the disclosure clearer, the technical solutions of the disclosure will be clearly described below in conjunction with specific embodiments and corresponding drawings. Obviously, the embodiments described below are only a part of the embodiments of the disclosure, rather than all of them. Without conflict, the various embodiments and their technical features described below may be combined with each other and also fall within the technical solutions of the disclosure.

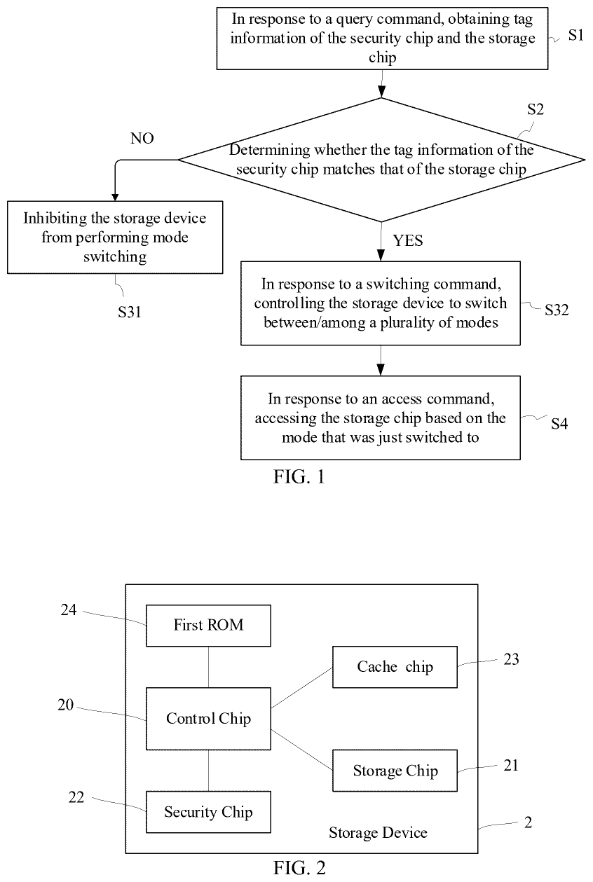

FIG. 1 is a schematic flowchart of a data management method according to an embodiment of the disclosure. The data management method may also be referred to as the “method” and is applicable to a storage device. The executing subject of each step of thereof may be the storage device, or storage media, processors, controllers, etc. having a data management functions. The storage device includes a storage chip, a control chip, and a security chip coupled to the control chip. The storage device includes but is not limited to, an SSD (such as Solid State Disk or Solid State Drive), a USB flash drive, or an embedded Multi Media Card (eMMC).

Referring to FIG. 1, the method includes at least the following steps S1 to S4.

In step S1: in response to a query command, obtaining tag information of the security chip and the storage chip.

In step S2: determining whether the tag information of the security chip matches that of the storage chip. When the tag information of the security chip does not match that of the storage chip, performing a step S31. When the tag information of the security chip matches that of the storage chip, perform a step S32. Specifically, in step S31, inhibiting the storage device from performing mode switching; then, it can return to continue performing step S1 and step S2. In step S32, in response to a switching command, controlling the storage device to switch between/among a plurality of modes.

In step S4: in response to an access command, accessing the storage chip based on the mode that was just switched to.

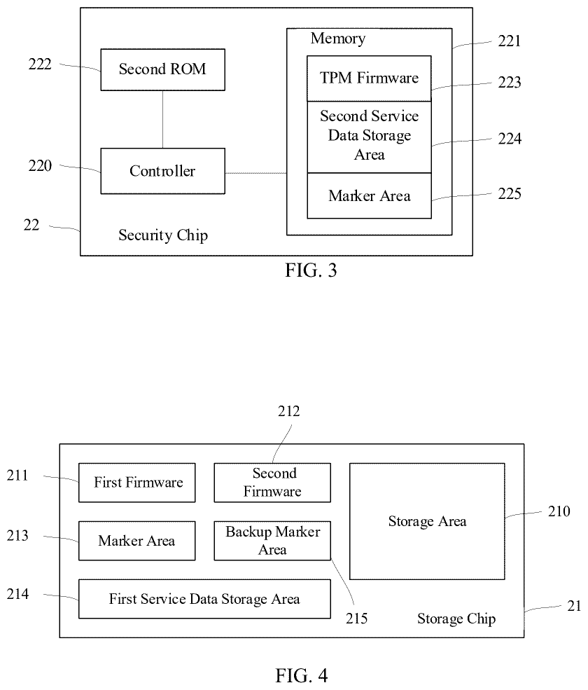

Referring to FIGS. 2 to 4, the storage device 2 includes a storage chip 21, and a security chip 22. It should be understood that as a complete storage device, the storage device 2 may further include a control chip 20, a cache chip 23, and a first Read-Only Memory(ROM) 24. The control chip 20 refers to the above control chip that is coupled to the security chip 22.

The storage chip 21 includes a storage area 210, a first firmware 211, a second firmware 212, a marker area 213, a first service data storage area 214, and a backup marker area 215. The storage area 210 is configured to store data for reading, writing, and backup operations of the storage device 2, which is also known as a valid storage area. The first service data storage area 214 mainly includes a service data area, a communication data area, and a key data area. Specifically, the service data area is configured to store communication data with a host; the communication data area is configured to store communication data between various components within the storage device 2; and the key data area is configured to store encryption and decryption-related data such as keys. The marker area 213 is configured to store tag information indicating the current state of the storage chip 21.

The security chip 22 includes a controller 220, a memory 221, and a second ROM 222. The memory 221 includes Trusted Platform Module (TPM) firmware 223, a second service data storage area 224, and a marker area 225. The structure and function of the second service data storage area 224 are similar to those of the first service data storage area 214. For example, the second service data storage area 224 can also include a service data area, a communication data area, and a key data area. The service data area is configured to store communication data with the control chip 20, the communication data area is configured to store communication data between various components within the storage device 2, and the key data area is configured to store encryption and decryption-related data such as keys. The marker area 225 is configured to store tag information indicating a current state of the security chip 22.

Taking an actual scenario as an example, in the step S1, a tag value F₁ is read from the marker area 225 of the security chip 22 and a tag value F₂ is read from the marker area 213 of the storage chip 21. In the step S2, when the tag values F₁ and F₂ read from the security chip 22 and the storage chip 21 are consistent, it is determined that they match. When the tag values F₁ and F₂ read from the security chip 22 and the storage chip 21 are different, it is determined that they do not match.

In practical implementations, referring to FIG. 2, the storage device 2 can communicate with a host (also known as the Host end or upper computer) and receive relevant commands from the host, including query commands and access commands issued by the user, and perform corresponding steps according to these commands.

First, the host powers on the storage device 2, which includes two power supply modes: a first power source and a second power source. The security chip 22 is preferentially powered on through the first power source, followed by powering on other components shown in FIG. 2 (except for the security chip 22) through the second power source, ensuring data security through the security chip 22.

After the security chip 22 is powered on, its the controller 220 starts and communicates with the second ROM 222 to execute a startup program stored therein. The final segment of this startup program is a jump command which redirects execution to the TPM firmware 223 within the memory 221 of the security chip 22. The TPM firmware 223 queries the tag information in the marker area 225 of the security chip 22, when executing the first command of a query command. For example, when the queried tag value F₁ is the first tag value, it indicates that the security chip 22 is currently in a blank state. When the queried tag value F₁ is the second tag value, it indicates that the security chip 22 is currently in an initialized state.

After other components in the storage device 2 are powered on, the system waits for the security chip 22 to complete its startup. After completes startup, the security chip 22 sends a startup command to the control chip 20. The control chip 20 then initiates a startup program stored in the first ROM 24. The final segment of this startup program is a jump command that redirects execution to the storage chip 21, specifically to the first firmware 211 within the storage chip 21. The first segment command in the first firmware 211 queries the marker area 213 of the storage chip 21 to obtain tag information and queries the tag information in the marker area 225 of the security chip 22. For example, when the queried tag value F₂ is the first tag value and the queried tag value F₁ from the marker area 225 of the security chip 22 is the first tag value, this indicate the storage chip 21 is currently in a normal state, and the first firmware 211 can continue to execute its driver program (a first mode of the plurality of modes). When the queried tag value F₂ is the second tag value and the queried tag value F₁ from the marker area 225 of the security chip 22 is the second tag value, this indicates the storage chip 21 is currently in a special state, and execution may jump to the second firmware 212, where the second firmware 212 executes the relevant driver program (a second mode of the plurality of modes).

Before the storage device 2 switches modes, the host first send a query command to the storage device 2. The storage device 2 may determine whether the current states of the storage chip 21 and the security chip 22 match by adopting the aforementioned method of querying tag values from the marker areas. Alternatively, the storage device 2 may send the obtained tag information to the host, which then verifies whether the current states of the storage chip 21 and the security chip 22 match. Since the tag information indicates the current state of each chip, and the current states of the storage chip 21 and the security chip 22 may be deemed the current state of the storage device 2.

The storage device 2 may first query the current state of the security chip 22 and then that of the storage chip 21. Alternatively, it may query the storage chip 21 first and followed by the security chip 22. No specific limitation is imposed here. Specifically, when the tag value F₁ of the security chip 22 is the first tag value, it indicates a blank state, while the tag value F₂ of the storage chip 21 is the first tag value, it indicates a normal state. When both the tag value F₁ of the security chip 22 and the tag value F₂ of the storage chip 21 are the first tag value, the storage device 2 determines that it is currently in the first mode. In this first mode, the storage device 2 uses a second key of the storage chip 21 by default.

When the tag value F₁ of the security chip 22 is the second tag value, it indicates an initialized state, and when the tag value F₂ of the storage chip 21 is the second tag value, it indicates a special state. When both the tag value F₁ of the security chip 22 and the tag value F₂ of the storage chip 21 are the second tag value, the storage device 2 determines that it is currently in the second mode. In this second mode, it uses a first key by default. Additionally, the storage device 2 supports a mode-switching command for switching modes only when the tag values F₁ and F₂ are consistent.

When the security chip 22 is currently in a blank state while the storage chip 21 is currently in a special state, or when the security chip 22 is currently in an initialized state while the storage chip 21 is currently in a normal state, the storage device 2 identifies both scenarios as state errors. The occurrence of either of these scenarios indicates that the mode switching of the storage device 2 has failed. In such cases, the storage device 2 may return an error code to the host and will not process any other commands.

It may be seen that the storage device 2 can only be normally started and support mode switching when the tag values F₁ and F₂ of the security chip 22 and the storage chip 21 are consistent. This is equivalent to requiring dual authentication from both the security chip 22 and the storage chip 21 for mode switching, thereby more effectively preventing malicious attackers from cracking encrypted data by software means, and achieving superior security.

The first mode and the second mode among the plurality modes may be regarded as two modes with different encryption levels. The encryption level of the first mode may be lower than that of the second mode. For example, the first mode may be referred to as a normal mode, representing the mode started by the first firmware 211, while the second mode may be referred to as a special mode, representing the mode started by the second firmware 212. The storage device 2 thus support dual usage, that is, it enables switching from the special mode to the normal mode and from the normal mode to the special mode.

Based on the above, when the tag information of the security chip 22 matches that of the storage chip 21, the disclosure can control the storage device 2 to switch between different modes and access the storage chip 21 based on the mode was just switched to. The communication methods between the storage chip 21 and the security chip 22 vary across different modes. During the data read/write operations, the storage device 2 does not always obtain the key from the security chip 22 or perform identity authentication in the same mode, which helps achieving a balance between security and convenience.

For example, in the first mode, the storage device 2 defaults to using the key of the storage chip 21, this configuration reduces signaling interactions with the security chip 22, minimizes impacts on data transmission, and thus ensures the convenience of data read/write operations. In the second mode, the storage device 2 defaults to using the key of the security chip 22, thereby ensuring the security of data read/write operations.

Next, the implementation process and principles of switching between the first mode and the second mode in the disclosure are introduced.

### First Scenario: Switching From the First Mode to the Second Mode

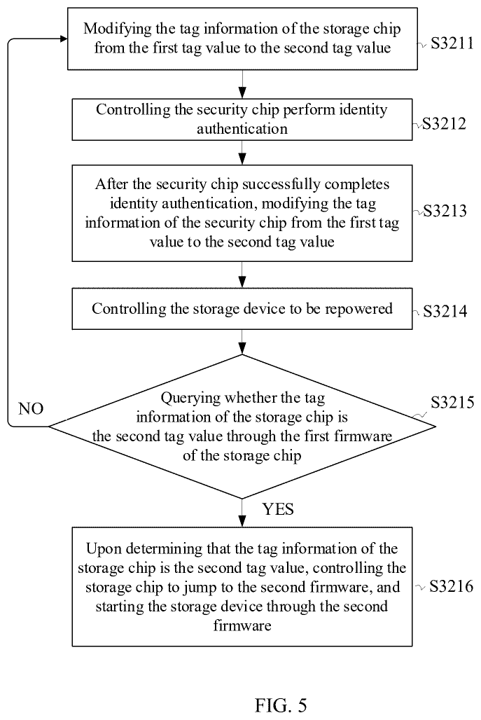

Referring to FIG. 5, step S32 may be implemented as the following steps:

In step S3211: modifying the tag information of the storage chip from the first tag value to the second tag value.
In step S3212: controlling the security chip perform identity authentication.
In step S3213: after the security chip successfully completes identity authentication, modifying the tag information of the security chip from the first tag value to the second tag value.
In step S3214: controlling the storage device to be repowered.
In step S3215: querying whether the tag information of the storage chip is the second tag value through the first firmware of the storage chip.
In step S3216: upon determining that the tag information of the storage chip is the second tag value, controlling the storage chip to jump to the second firmware, and starting the storage device through the second firmware.

When the tag information of the storage chip is queried to be the first tag value, the process can return to step S3211 until the tag information of the storage chip is queried to be the second tag value.

The first tag value and the second tag value may be understood as tag values 0 and 1, respectively. For the convenience of expression, this embodiment takes the first tag value as 0 and the second tag value as 1 as an example, but the disclosure is not limited thereto.

Referring to FIGS. 2-4, after the control chip 20 of the storage device 2 determines that the current states of the storage chip 21 and the security chip 22 match, the control chip 20 modifies the tag value stored in the marker area 213 of the storage chip 21 from a first tag value (i.e., 0) to a second tag value (i.e., 1); and forwards a command to instruct the security chip 22 to execute identity authentication. For example, the control chip 20 transmits a command carrying a digital signature to the security chip 22, wherein the digital signature is configured to uniquely identify the host that communicates with the storage device 2. The control chip 20 then controls the security chip 22 to parse the command to extract the digital signature; and verify the digital signature by decrypting it, thereby safeguarding the security of the storage device 2 and preventing malicious tampering with its data. In practical application scenarios, the digital signature carried in the command is generated by the host using the SM2 encryption algorithm. After receiving the command, the security chip 22 parses it to obtain the digital signature and performs the signature verification operation (i.e., decrypting the digital signature). For specific implementation details of SM2-based encryption and decryption, reference may be made to existing technologies in this technical field, which are not elaborated herein. When the security chip 22 successfully decrypts the digital signature (this result indicates that the identity authentication is passed), the tag value in the marker area 225 of the secure chip 22 is modified from the first tag value (i.e., 0) to the second tag value (i.e., 1), the storage device 2 is subsequently repowered.

After the security chip 22 completes startup as described above, the first segment command of the first firmware 211 in the storage chip 21 queries the tag information in the marker area 213. When the current tag value is 1 (i.e., the second tag value), the first firmware 211 jumps to the second firmware 212, thereby completing starting of the storage device 2 and switching the current mode from the first mode to the second mode.

### Second Scenario: Switching From The Second Mode To The First Mode

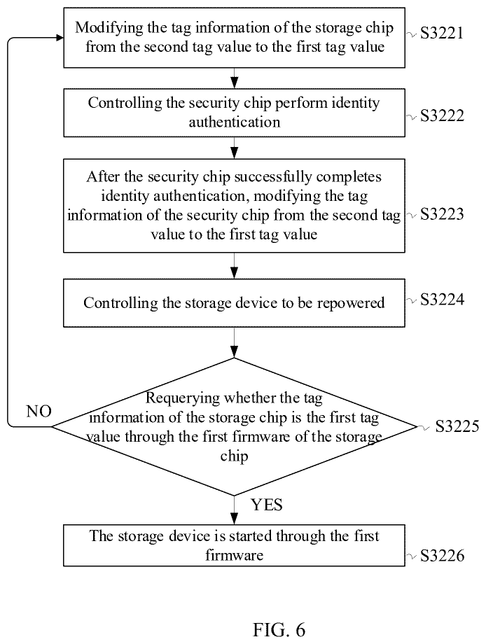

Referring FIG. 6, step S32 may be implemented as the following steps:
In step S3221: modifying the tag information of the storage chip from the second tag value to the first tag value.
In step S3222: controlling the security chip perform identity authentication.
In step S3223: after the security chip successfully completes identity authentication, modifying the tag information of the security chip from the second tag value to the first tag value.
In step S3224: controlling the storage device to be repowered.
In step S3225: requerying whether the tag information of the storage chip is the first tag value through the first firmware of the storage chip.
In step S3226: when it is queried that the tag information of the storage chip is the first tag value, the storage device is started through the first firmware. When it is queried that the tag information of the storage chip is the second tag value, the process can return to step S3221 until the tag information of the storage chip is queried to be the first tag value.

Referring to FIGS. 2-4, after determining that the current states of the storage chip 21 and the security chip 22 match, the control chip 20 of the storage device 2 modifies the tag value in the marker area 213 of the storage chip 21 from 1 (i.e., the second tag value) to 0 (i.e., the first tag value), and forwards a command to the security chip 22. The command carries a digital signature generated by the host based on the SM2 encryption algorithm. After receiving the command, the security chip 22 parses it to obtain the digital signature and performs signature verification (i.e., decryption). When the decryption is successful (indicating that the identity authentication is passed), the tag value in the marker area 225 is modified from 1 (i.e., the second tag value) to 0 (i.e., the first tag value). Subsequently, the storage device 2 is then repowered in accordance with the foregoing principle, and the security chip 22 does not need to be repowered. After the secure chip 22 completes its startup as described above, the first segment command of the first firmware 211 in the storage chip 21 queries the tag information in the marker area 213. When the current tag value is 0 (i.e., the first tag value), the first firmware 211 does not jump and proceeds to execute its subsequent commands, thereby completing starting of the storage device 2 and switching from the second mode to the first mode.

In any of the foregoing mode switching scenarios, the storage device 2 does not receive access commands from the host during the mode switching process; when it receives such commands, it will not execute the corresponding access operations.

In addition, during the switching process between the first mode and the second mode, the order of modifying the tag value of the storage chip 21 and the tag value of the security chip 22 in the foregoing steps is not specifically limited; either tag value may be modified first.

In the step S4, accessing the storage chip 21 includes the host sending a data read or write command to the control chip 20, and the control chip 20 performing encryption or decryption on the data to be read or written.

### EXAMPLE 1

Specifically, the step S4 may be implemented as process where, after switching from the first mode to the second mode, the control chip 20 performs encrypting/decrypting on the data to be read or written:
In step S411: sending a request for the first key to the security chip.
In step S412: controlling the security chip perform identity authentication.
In step S413: after the security chip successfully completes identity authentication, in response to receiving the first key from the security chip, caches the first key, and encrypts or decrypts the data to be read or written using the first key.

Referring to FIGS. 2-4, in the second mode, the encryption and decryption keys for data are stored in the second service data storage area 224 of the security chip 22. The host sends a command carrying an SM2-based digital signature. The storage device 2 forms this digital signature into a request and sends it to the security chip 22 to obtain the first key. The control chip 20 may send the request to the security chip 22 using the NVMe protocol via a Serial Peripheral Interface (SPI). Upon receiving the request, the security chip 22 verifies the included digital signature. If the verification is successful (indicating that the identity authentication is passed), the security chip 22 sends the first key stored therein to the control chip 20, which then temporarily caches the first key in the cache chip 23. Subsequently, the host can send a data write command to the control chip 20 of the storage device 2 through the NVMe protocol. After receiving and parsing the command, the control chip 20 encrypts the data using the SM4 encryption algorithm associated with the first key and stores the encrypted data in the storage area 210 of the storage chip 21.

It should be noted that the first key used for SM4 encryption originates from the second service data storage area 224 of the security chip 22. Similarly, the host can also send a data read command to the control chip 20 of the storage device 2 through the NVMe protocol. After receiving and parsing the command, the control chip 20 obtains the first key cached in the cache chip 23, and then obtains the data from the storage area 210 of the storage chip 21 through the SM4 decryption. The first key used for performing SM4 encryption and decryption is the same key. For the SM4-based encryption and decryption processes, reference may be made to existing technologies in this field, which will not be elaborated on herein.

In step S413, after receiving the first key, the storage device 2 only caches the first key, for example, in the cache chip 23 shown in FIG. 2, and does not store it in the storage area 210 of the storage chip 21. In the second mode, in response to the storage device 2 being powered off, the first key is discarded, and in response to the storage device 2 being powered on, step S411 is executed. Specifically, in the second mode, the storage device 2 only uses the first key from the security chip 22 and does not store it. The first key must be reacquired each time the storage device 2 is repowered.

The above Example 1, may be deemed the data read/write operations following the switch from the first mode to the second mode.

### EXAMPLE 2

Step S4 may refer to the process where, the control chip 20 encrypts or decrypts the data to be read or written, after switching from the second mode to the first mode, the control chip 20 encrypts/decrypts the data to be read or written:

Obtaining the second key from the storage chip 21 and encrypting or decrypting the data in the storage chip 21 using the second key.

Referring to FIGS. 2-4, the host may send a data write command to the control chip 20 of the storage device 2 through the NVMe protocol. The control chip 20 receives and parses the command, the data is then stored in the storage area 210 of the storage chip 21 by means of SM4 encryption. It should be noted that the second key used for SM4 encryption is derived from the first service data storage area 214 of the storage chip 21. Similarly, the host may send a data read command to the control chip 20 of the storage device 2 via the NVMe protocol. The control chip 20 receives and parses the command, and then obtains the data from the storage area 210 of the storage chip 21 using the second key and the SM4 decryption method. The second key used for performing SM4 encryption and decryption is the same key.

The Example 2 may be deemed the data read/write operations following the switch from the second mode to the first mode.

Step S32 also includes backing up the data in the valid storage area of the storage chip 21, which will be elaborated on in examples 3 and 4.

### EXAMPLE 3

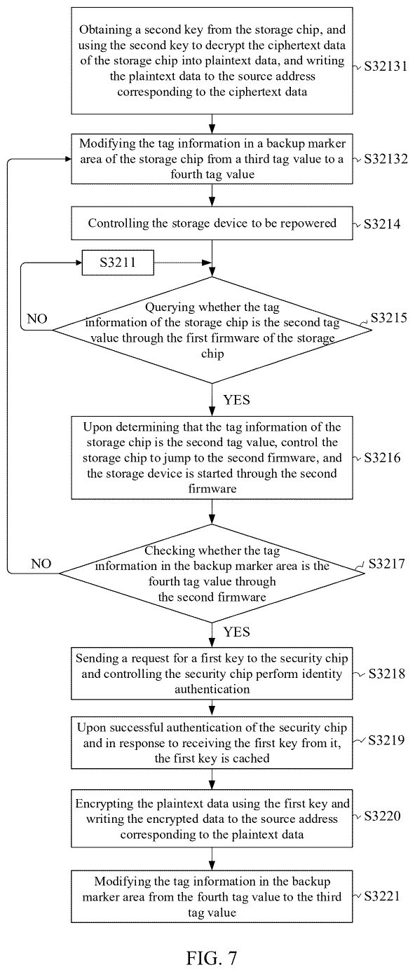

Referring to FIGS. 5-7, during the switch from the first mode to the second mode, the following steps may be performed subsequent to step S3213:
In step S32131: obtaining a second key from the storage chip, and using the second key to decrypt the ciphertext data of the storage chip into plaintext data, and writing the plaintext data to the source address corresponding to the ciphertext data.
In step S32132: modifying the tag information in a backup marker area of the storage chip from a third tag value to a fourth tag value.
In step S3214: controlling the storage device to be repowered.
In step S3215: querying whether the tag information of the storage chip is the second tag value through the first firmware of the storage chip; if not, performing step S3211; if yes, performing step S3216.
In step S3216: upon determining that the tag information of the storage chip is the second tag value, control the storage chip to jump to the second firmware, and the storage device is started through the second firmware.
In step S3217: checking whether the tag information in the backup marker area is the fourth tag value through the second firmware.
In step S3218: when the tag information in the backup marker area is the fourth tag value, sending a request for a first key to the security chip and controlling the security chip perform identity authentication; if not, continue performing step S32132.
In step S3219: upon successful authentication of the security chip and in response to receiving the first key from it, the first key is cached.
In step S3220: encrypting the plaintext data using the first key and writing the encrypted data to the source address corresponding to the plaintext data.
In step S3221: modifying the tag information in the backup marker area from the fourth tag value to the third tag value.

Referring to FIGS. 2-4, after modifying the tag information of the security chip 22 from the first tag value to the second tag value, the control chip 20 of the storage device 2 retrieves the second key from the first service data storage area 214 of the storage chip 21 (and caches it in the cache chip 23 upon retrieval if needed). The control chip 20 then uses the second key to decrypt the ciphertext data in the storage area 210 into plaintext data and writes the plaintext to the source address corresponding to the ciphertext data—i.e., the address of the ciphertext data in the storage area 210 prior to mode switching (i.e., in the first mode). Subsequently, the control chip 20 modifies the tag information in the backup marker area 215 from the third tag value (i.e., 0) to the fourth tag value (i.e., 1), where the third tag value indicates that data backup does not require encryption and the fourth tag value indicates that data backup requires encryption. The control chip 20 then executes steps S3214 to S3216 as described above. Afterward, the second firmware 212 verifies the tag information in the backup marker area 215; if the tag value is the fourth tag value, the control chip 20 receives the first key from the security chip 22 (which has successfully completed identity authentication), encrypts the plaintext data using the first key, and finally writes the encrypted data to source address corresponding to the plaintext data. This completes the data backup process following the mode switch.

The third tag value and fourth tag value may be understood as a tag value of 0 and a tag value of 1, respectively. For the convenience of description, the disclosure takes the third tag value as 0 and the fourth tag value as 1 as an example, but the disclosure is not limited thereto.

After switching from the first mode to the second mode and completing data backup, the data read/write operations described in embodiment 1 above may continue to be performed.

### EXAMPLE 4

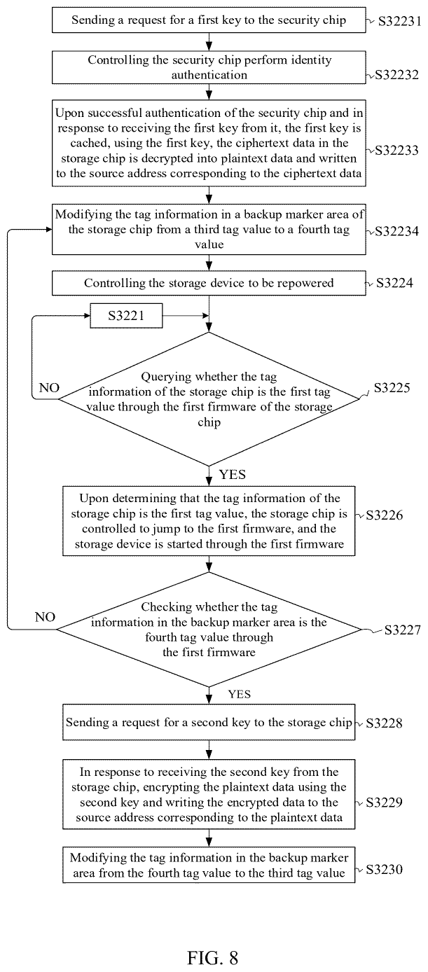

Referring to FIGS. 6 to 8, during the process of switching from the second mode to the first mode, the following steps may be performed after step S3223:
In step S32231: sending a request for a first key to the security chip.
In step S32232: controlling the security chip perform identity authentication.
In step S32233: upon successful authentication of the security chip and in response to receiving the first key from it, the first key is cached, using the first key, the ciphertext data in the storage chip is decrypted into plaintext data and written to the source address corresponding to the ciphertext data.
In step S32234: modifying the tag information in a backup marker area of the storage chip from a third tag value to a fourth tag value.
In step S3224: controlling the storage device to be repowered.
In step S3225: querying whether the tag information of the storage chip is the first tag value through the first firmware of the storage chip; if not, performing step S3221; if yes, performing step S3226.
In step S3226: upon determining that the tag information of the storage chip is the first tag value, the storage chip is controlled to jump to the first firmware, and the storage device is started through the first firmware.
In step S3227: checking whether the tag information in the backup marker area is the fourth tag value through the first firmware.
In step S3228: if yes, sending a request for a second key to the storage chip; if not, continue to performing step S32234.
In step S3229: in response to receiving the second key from the storage chip, encrypting the plaintext data using the second key and writing the encrypted data to the source address corresponding to the plaintext data.
In step S3230: modifying the tag information in the backup marker area from the fourth tag value to the third tag value.

As shown in FIGS. 6-8, after modifying the tag information of the security chip 22 from the second tag value to the first tag value, the control chip 20 of the storage device 2 sends a request to the security chip 22 for the first key and control the security chip 22 to perform identity authentication. Upon the security chip 22's successful completion of identity authentication, and in response to receiving the first key from the security chip 22, the control chip 20 caches the first key, then uses the first key to decrypt the ciphertext data of the storage chip 21 into plaintext data and writes the plaintext to the source address corresponding to the ciphertext—i.e., the address of the ciphertext data in the storage area 210 prior to mode switching (i.e., in the second mode). Subsequently, the control chip 20 modifies the tag information in the backup marker area 215 from the third tag value to the fourth tag value, where the third tag value indicates that data backup does not require encryption and the fourth tag value indicates that data backup requires encryption. The control chip 20 then executes steps S3224 to S3226 as described above. Afterward, the first firmware 211 verifies the tag information in the backup marker area 215; if the tag value is the fourth tag value, the control chip 20 retrieves the second key from the first service data storage area 214 of the storage chip 21, uses the second key to encrypt the plaintext data in the storage area 210 into ciphertext data, and writes the ciphertext to the source address corresponding to the plaintext data. This completes the data backup process following the mode switch.

After switching from the second mode to the first mode and completing data backup, the storage device 2 may continue to perform data read/write operations as described in the example 2 above.

In steps S3221 and S3230, modifying the tag information in the backup marker area 215 from the fourth tag value to the third tag value restores the tag information to a state where data backup does not require encryption after each backup. This facilitates subsequent backups, whether in mode switching scenarios or non-mode switching scenarios.

It should be noted that for a specific technical feature in the embodiments of the disclosure, if there are multiple scenarios and feasible implementation methods without special instructions, the corresponding technical feature may be achieved through appropriate combined configurations. For example, the implementation methods of the aforementioned mode switching, data backup of the valid storage area, and data read/write operations after mode switching may be combined to achieve access to the storage chip 21. This combined solution can implement the corresponding technical features more accurately and/or intelligently, thereby enhancing the accuracy of the technical feature implementation and improving the user experience.

During the switching between the first mode and the second mode, the process further includes:
In step S3213: after the security chip 22 successfully completes identity authentication, modifying the tag information of the security chip 22 from the first tag value to the second tag value.
In step S3223: after the security chip 22 successfully completes identity authentication, modifying the tag information of the security chip 22 from the second tag value to the first tag value.

After steps S3213 and S3223, the control chip 20 of the storage device 2 may format the storage area 210 of the storage chip 21.

During the switch between the first mode and the second mode, the repowering the storage device 2 comprises: repowering the storage device 2 in steps S3214 and S3224.The repowering may be understood as repowering components other than the security chip 22, whereas the security chip 22 does not require repowering. In practical scenarios, the storage device 2 may be provided with a first power source and a second power source. The first power source is configured to provide power to the security chip 22, and the second power source is configured to provide power to components other than the security chip 22. Based on this configuration, in response to a mode switch command, the disclosure can control the first power source of the storage device 2 to maintain power supply to the security chip 22, while controlling the second power source to cut off power the components other than the security chip 22. Correspondingly, after repowering, the second power supply is controlled to resume power supply to the components other than the security chip 22. By configuring the first and second power sources, the security chip 22 remains powered during the repowering process. This design not only improves restart efficiency but also ensures the security of data in the storage chip 21, preventing malicious attacks during repowering process.

The embodiments of the disclosure further provide a controller capable of executing the method according to any of the aforementioned implementations to manage data of the storage device, thereby achieving a balance between security and convenience during data read/write operations. For related details, reference may be made to the aforementioned embodiments, and no further elaboration is provided herein.

The embodiments of the disclosure further provide a storage device. For example, the storage device may include a host interface and a controller; optionally, it may also include a storage module, which may be coupled to the controller via a storage interface. The host interface is configured to connect to an external host (e.g., the host in the aforementioned method embodiments) for receiving various requests and commands from the external host; the controller is configured to execute the steps of the data management method according to any of the aforementioned embodiments to implement mode switching and data access. For specific principles, processes, and beneficial effects, reference may be made to the aforementioned embodiments, and no further elaboration is provided herein.

The embodiments of the disclosure further provide another storage device, which includes a storage chip, a control chip, and a security chip coupled to the control chip. Wherein:

The control chip is configured to acquire tag information of the security chip and the storage chip in response to a query command, and to determine whether the tag information of the security chip and the storage chip match.

When they do not match, the storage device is prohibited from performing mode switching.

When they match, in response to a switching command, the control chip controls the storage device to switch between/among a plurality of modes; and in response to an access command, accesses the storage chip based on the mode was just switched to.

In an example of determining whether the tag information of the security chip matches that of the storage chip, the security chip and the storage chip are respectively provided with marker areas for storing corresponding tag values; the control chip reads the tag values from the marker areas of the security chip and the storage chip respectively and determines whether the two tag values are consistent. When they are consistent, it is determined to be a match; when they are different, it is determined to be a mismatch.

In an example, the storage chip is provided with a second firmware;

The storage chip is configured to modify its tag information from a first tag value to a second tag value;

The security chip is used perform identity authentication and, after successfully completing identity authentication, modify its tag information from the first tag value to the second tag value;

After the storage device is repowered, the first firmware is configured to query whether the tag information of the storage chip is the second tag value, and when the tag information is queried to be the second tag value, jump to the second firmware to start the storage device through the second firmware.

In an example, the storage device also includes a cache chip, and the control chip is further configured to send a request for a first key to the security chip.

The security chip is used perform identity authentication after receiving the request and, after successfully completing identity authentication, send the first key to the control chip.

The control chip is configured to receive the first key sent by the security chip and cache the first key in the cache chip; the storage chip is configured to encrypt or decrypt data read or written by the control chip through the first key.

In an example, the storage device also includes a cache chip, and the control chip is further configured to acquire a second key from the storage chip, the storage chip is configured to decrypt its ciphertext data into plaintext data through the second key and write the plaintext data to the source address corresponding to the ciphertext data; the storage chip is further configured to modify the tag information in its backup marker area from a third tag value to a fourth tag value.

The second firmware is configured to check whether the tag information in the backup marker area is the fourth tag value.

When it is, the control chip is further configured to send a first key request to the security chip, the security chip is used perform identity authentication after receiving the request and, after successfully completing identity authentication, send the first key to the control chip; the control chip is further configured to receive the first key from the security chip and cache the first key in the cache chip.

The storage chip is further configured to encrypt its plaintext data through the first key and write the encrypted data to the source address corresponding to the plaintext data; the storage chip is further configured to modify the tag information in the backup marker area from the fourth tag value to the third tag value.

In an example, the storage chip is provided with a first firmware.

The storage chip is configured to modify its tag information from the second tag value to the first tag value.

The security chip is configured to perform identity authentication and, after successfully completing identity authentication, modify its tag information from the second tag value to the first tag value.

After the storage device is repowered, the first firmware is configured to query whether the tag information of the storage chip is the first tag value and, upon determining that the tag information is queried to be the first tag value, jump to the first firmware to start the storage device through the first firmware.

In an example, the storage chip is further configured to encrypt or decrypt data being read or written by the control chip through a second key.

In an example, the storage device also includes a cache chip, and the control chip is further configured to send a request for a first key to the security chip, the security chip is used perform identity authentication after receiving the request and, after successfully completing identity authentication, send the first key to the control chip.

The control chip is further configured to receive the first key from the security chip and cache the first key in the cache chip; the storage chip is further configured to decrypt its ciphertext data into plaintext data through the first key and write the plaintext data to the source address corresponding to the ciphertext data, and the storage chip is further configured to modify the tag information in its backup marker area from a third tag value to a fourth tag value.

The first firmware checks whether the tag information in the backup marker area is the fourth tag value.

When it is, the control chip is further configured to send a request for a second key to the storage chip, the storage chip encrypts the plaintext data through the second key and writes the encrypted data to the source address corresponding to the plaintext data; the storage chip is further configured to modify the tag information in the backup marker area from the fourth tag value to the third tag value.

In an example, the storage device also includes a first power source and a second power source; the storage device controls the first power source to maintain power to the security chip and the second power source to cut off power to components other than the security chip; the storage device controls the second power source to resume power supply to components other than the security chip.

The structure of the storage device in this embodiment can refer to the storage device 2 shown in the aforementioned FIG. 2, which is configured to execute the steps of the data management method in any of the aforementioned embodiments to achieve mode switching and access operations. For specific principles, processes, and beneficial effects, refer to the above-mentioned embodiments, and no further elaboration will be provided here.

It should be understood that the storage device and the controller provided in the embodiments of the present application are complete devices and also have the structures of corresponding known devices. Here, only the components related to data management (also referred to as storage management) in the devices are described, and no further elaboration will be provided on other components.

The above are only some embodiments of the present application and do not limit the patent scope of the present application. For ordinary technicians in the field, any equivalent structural transformations made using the content of this specification and the accompanying drawings shall fall within the patent protection scope of the present application.

This document uses step codes such as S1, S2, etc., for the purpose of more clearly and briefly expressing the corresponding content, and does not constitute a substantive limitation on the order. When implementing in practice, technicians in the field may perform S31 first and then S1, etc., but these shall all fall within the protection scope of the present application.

Although terms such as “first,” “second,” etc. are used in this document to describe various types of information, these information should not be limited to these terms. These terms are only used to distinguish the same type of information from each other. In addition, the singular forms “a,” “an,” and “the” are intended to also include the plural forms. The terms “or” and “and/or” are interpreted as inclusive, meaning either one or any combination. Exceptions to this definition will only occur when the combination of elements, functions, steps, or operations is inherently mutually exclusive in some way.

1. A data management method for a storage device, the storage device comprising a storage chip, a control chip, and a security chip coupled to the control chip, and the data management method comprising:
in response to a query command, obtaining tag information of the security chip and the storage chip;
determining whether the tag information of the security chip matches that of the storage chip;
when the tag information of the security chip does not match that of the storage chip, inhibiting the storage device from performing mode switching;
when the tag information of the security chip matches that of the storage chip, in response to a switching command, controlling the storage device to switch between/among a plurality of modes; and
in response to an access command, accessing the storage chip based on the mode that was just switched to.

2. The data management method according to claim 1, wherein obtaining tag information of the security chip and the storage chip comprises: reading tag values from a marker area of the security chip and a marker area of the storage chip; and
wherein determining whether the tag information of the security chip matches that of the storage chip comprises:
when the tag value read from the security chip and that read from the storage chip are consistent, determining that the tag information of the security chip matches that of the storage chip;

3. The data management method according to claim 1, wherein to switch between/among the plurality of modes comprises:
modifying the tag information of the storage chip from a first tag value to a second tag value;
controlling the security chip perform identity authentication;
after the security chip successfully completes identity authentication, modifying the tag information of the security chip from the first tag value to the second tag value;
controlling the storage device to be repowered;
querying whether the tag information of the storage chip is the second tag value through the first firmware of the storage chip;
when the tag information of the storage chip is the second tag value, controlling the storage chip to jump to the second firmware and starting the storage device through the second firmware.

4. The data management method according to claim 3, wherein accessing the storage chip based on the mode was just switched to comprises:
sending a request for a first key to the security chip and controlling the security chip perform identity authentication;
after the security chip successfully completes identity authentication, in response to receiving the first key from the security chip, caching the first key, and using the first key to encrypt or decrypt the data being read or written.

5. The data management method according to claim 3, wherein controlling the storage device to switch between/among the plurality of modes comprises:
obtaining a second key from the storage chip, and using the second key to decrypt the ciphertext data of the storage chip into plaintext data, and writing the plaintext data to the source address corresponding to the ciphertext data;
modifying the tag information in a backup marker area of the storage chip from a third tag value to a fourth tag value;
checking whether the tag information in the backup marker area is the fourth tag value through the second firmware ;
when the tag information in the backup marker area is the fourth tag value, sending a request for a first key to the security chip and controlling the security chip perform identity authentication;
after the security chip successfully completes identity authentication, in response to receiving the first key from the security chip, caching the first key;
encrypting the plaintext data using the first key and writing the encrypted data to the source address corresponding to the plaintext data;
modifying the tag information in the backup marker area from the fourth tag value to the third tag value.

6. The data management method according to claim 1, wherein controlling the storage device to switch between/among the plurality of modes comprises:
modifying the tag information of the storage chip from a second tag value to a first tag value;
controlling the security chip to perform identity authentication;
after the security chip successfully completes identity authentication, modifying the tag information of the security chip from the second tag value to the first tag value;
controlling the storage device to be repowered;
querying whether the tag information of the storage chip is the first tag value through the first firmware of the storage chip;
when it is queried that the tag information of the storage chip is the first tag value, starting the storage device through the first firmware.

7. The data management method according to claim 6, wherein accessing the storage chip based on the mode was just switched to comprises:
obtaining a second key from the storage chip and using the second key to encrypt or decrypt the data being read or written.

8. The data management method according to claim 6, wherein the step of controlling the storage device to switch between/among the plurality of modes comprises:
sending a request for a first key to the security chip and controlling the security chip perform identity authentication;
after the security chip successfully completes identity authentication, in response to receiving the first key from the security chip, caching the first key, using the first key to decrypt the ciphertext data of the storage chip into plaintext data, and writing the plaintext data to the source address corresponding to the ciphertext data;
modifying the tag information in the backup marker area of the storage chip from a third tag value to a fourth tag value;
checking whether the tag information in the backup marker area is the fourth tag value through the first firmware;
when the tag information in the backup marker area is the fourth tag value, sending a request for a second key to the storage chip;
in response to receiving the second key from the storage chip, encrypting the plaintext data using the second key and writing the encrypted data to the source address corresponding to the plaintext data; and
modifying the tag information in the backup marker area from the fourth tag value to the third tag value.

9. The data management method according to claim 3, wherein the step of controlling the storage device to switch between/among the plurality of modes further comprises:
formatting the storage area of the storage chip.

10. The data management method according to claim 3, wherein controlling the storage device to be repowered comprises:
controlling a first power source of the storage device to maintain power to the security chip, and controlling a second power source to cut off power to the components other than the security chip;
controlling the second power source to resume power supply to the components other than the security chip.

11. A storage device, comprising a storage chip, a control chip, and a security chip coupled to the control chip;
wherein, the control chip is configured to obtain tag information of the security chip and tag information of the storage chip in response to a query command; and to determine whether the tag information of the security chip matches that of the storage chip;
when the tag information of the security chip does not match that of the storage chip, the control chip is further configured to inhibit mode switching;
when the tag information of the security chip matches that of the storage chip, in response to a switching command, the control chip is further configured to control the storage device to switch between/among the plurality of modes; and in response to an access command, access the storage chip based on the mode was just switched to.

12. The storage device according to claim 11, wherein the control chip obtains tag information of the security chip and the storage chip by: reading tag values from a marker area of the security chip and a marker area of the storage chip; and
wherein the control chip determines whether the tag information of the security chip matches that of the storage chip by: when the tag value read from the security chip and that read from the storage chip are consistent, determining that the tag information of the security chip matches that of the storage chip; and when the tag value read from the security chip and that read from the storage chip are different, determining that the tag information of the security chip does not match that of the storage chip.

13. The storage device according to claim 11, wherein the storage chip is provided with a second firmware;
the storage chip is configured to modify its tag information from a first tag value to a second tag value;
the security chip is configured to perform identity authentication and after successfully completing identity authentication, modify its tag information from the first tag value to the second tag value;
upon repowering of the storage device, the first firmware is configured to query whether the tag information of the storage chip is the second tag value, and when the tag information is the second tag value, jump to the second firmware to start the storage device through the second firmware.

14. The storage device according to claim 12, wherein the storage device further comprises a cache chip, and the control chip is further configured to send a request for a first key to the security chip;
the security chip is configured to perform identity authentication after receiving the request and send the first key to the control chip after successfully completing identity authentication;
the control chip is configured to receive the first key sent by the security chip and cache the first key in the cache chip; the storage chip is configured to encrypt or decrypt the data being read or written by the control chip using the first key.

15. The storage device according to claim 12, wherein the storage device further comprises a cache chip;
the control chip is further configured to obtain a second key of the storage chip, the storage chip is configured to decrypt ciphertext data into plaintext data using the second key and write the plaintext data to the source address corresponding to the ciphertext data; the storage chip is further configured to modify the tag information in the backup marker area of the storage chip from a third tag value to a fourth tag value;
the security chip is configured to perform identity authentication after receiving the request, and send the first key to the control chip after successfully completing identity authentication;
the control chip is further configured to receive the first key from the security chip and cache the first key in the cache chip;
the storage chip is further configured to encrypt the plaintext data using the first key and write the encrypted data to the source address corresponding to the plaintext data; and modify the tag information in the backup marker area from the fourth tag value to the third tag value.

16. The storage device according to claim 11, wherein the storage chip is provided with a first firmware;
the storage chip is configured to modify its tag information from a second tag value to a first tag value;
the security chip is used perform identity authentication and, after successfully completing identity authentication, modify its tag information from the second tag value to the first tag value;
when the storage device is repowered, the first firmware is configured to query whether the tag information of the storage chip is the first tag value, and upon determining that the tag information is the first tag value, jump to the first firmware to start the storage device through the first firmware.

17. The storage device according to claim 15, wherein the storage chip is further configured to encrypt or decrypt the data read or written by the control chip using the second key.

18. The storage device according to claim 15, wherein the storage device further comprises a cache chip, and the control chip is further configured to send a request for a first key to the security chip, the security chip is used perform identity authentication after receiving the request and send the first key to the control chip after successfully completing identity authentication;
the control chip is further configured to receive the first key from the security chip and cache the first key in the cache chip; the storage chip is further configured to decrypt ciphertext data into plaintext data using the first key and write the plaintext data to the source address corresponding to the ciphertext data, the storage chip is further configured to modify the tag information in the backup marker area of the storage chip from a third tag value to a fourth tag value;
the first firmware checks whether the tag information in the backup marker area is the fourth tag value;
when the tag information in the backup marker area is the fourth tag value, the control chip is further configured to send a request for a second key to the storage chip, the storage chip encrypts the plaintext data using the second key and writes the encrypted data to the source address corresponding to the plaintext data; the storage chip is further configured to modify the tag information in the backup marker area from the fourth tag value to the third tag value.

19. The storage device according to claim 3, wherein the control chip is further configured to format the storage area of the storage chip.

20. The storage device according to claim 13, wherein the storage device further comprises a first power source and a second power source; the control chip is further configured to control the first power source to maintain power to the security chip and the second power source to cut off power to components other than the security chip; and control the second power source to resume power supply to the components other than the security chip.
